(19) United States
(12) Patent Application Publication
(10) Pub. No.: US 2017/0108942 A1
(43) Pub. Date: Apr. 20, 2017

(54) INPUT DEVICE AND METHOD, ENTERTAINMENT SYSTEM AND CONTROL METHOD

(71) Applicant: Sony Interactive Entertainment Inc., Tokyo (JP)

(72) Inventor: Rohan Pankaj Bangdiwala, London (GB)

(73) Assignee: Sony Interactive Entertainment Inc., Tokyo (JP)

(21) Appl. No.: 15/289,245

(22) Filed: Oct. 10, 2016

(30) Foreign Application Priority Data
Oct. 16, 2015 (GB) 1518362.7

(51) Int. Cl. G06F 3/0346; A63F 13/285; A63F 13/235; A63F 13/24; A63F 13/40

(52) U.S. Cl. CPC G06F 3/0346; A63F 13/24; A63F 13/40; A63F 13/235; A63F 13/285

(57) ABSTRACT

An input device for use with a processing apparatus, the input device comprising a transmitter operable to transmit user inputs to the processing apparatus, a receiver operable to receive control signalling from the processing apparatus, and a torque generating unit operable to generate torque responsive to the control signalling so as to increase the apparent mass of the input device when moved by a user.

### BACKGROUND OF THE INVENTION

Field of the invention

This application relates to input devices for entertainment systems, such as controllers for games consoles, a method of operating the input device, an entertainment system, and a method by which the entertainment system may control an aspect of the input device.

Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Input devices such as controllers are commonly used to interact with game systems, for example the DualShock 4® controller for the Sony® PlayStation 4®. Such devices allow users to input commands in order to control the processing of a game system, such as controlling a character in a game or navigating a menu.

It is an aim of computer games to provide an immersive experience; it is considered that a user may enjoy the interactive experience more when they are able to suspend their disbelief and consider the events in a game are real. This is especially true when considering the case of a game system that utilises a head mountable display (HMD) unit, as the immersive nature of the display lends itself to the suspension of disbelief more readily.

However, many controllers are not suitable for maintaining such an immersive experience. For example, an in-game character may be holding an object that simply does not correspond to the controller that is held by the user and therefore the user may be unable to reconcile this difference and as a result the sense of immersion may be broken. Arrangements to address this issue include specific controllers for a game, such as a steering wheel which may be bundled with a driving game, or attachments for controllers that seek to provide the shape of controller that the user could be led to expect, such as a clip-on golf club to be used for golf games. These attachments may incorporate new buttons in order to better simulate the use of the intended object.

These existing arrangements to address this problem have several associated drawbacks, as they require a different controller or attachment for each type of game; this creates a storage problem for the user as well as the user having to consider the cost of having a number of different accessories. The user would also be subject to the inconvenience of changing controller or attachment each time a new game or application is launched, which may also be time consuming as the attachments get more complex. Additionally, many of these arrangements are merely aesthetic and thus while the controller may look more like the object being used in-game there is no increase in the level of immersion experienced by the user.

It is an aim of the present disclosure to provide an arrangement that allows for a greater sense of immersion in a game environment.

### SUMMARY OF THE INVENTION

This disclosure is defined by claim 1.

Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment device;

FIG. 2 schematically illustrates an entertainment system;

FIG. 3 schematically illustrates an input device;

FIG. 4 schematically illustrates a torque generating arrangement;

FIG. 5 schematically illustrates an embodiment of an input device;

FIG. 6 schematically illustrates a torque generation process;

FIG. 7 schematically illustrates a signal generation process;

FIG. 8 schematically illustrates a predictive signal generation process.

### DESCRIPTION OF THE EMBODIMENTS

Referring now to the drawings, wherein like reference numerals designate identical or corresponding parts throughout the several views, embodiments of the present disclosure provide an apparatus which is operable to generate a torque so as to simulate the effect of weight in the apparatus. Such embodiments alleviate the problem of a break in immersion due to input devices held by a user not corresponding to in-game objects being held. The simulation of mass is advantageous as a difference between the expected mass of an in-game object (for example, a sword) and an input device that is held (such as a light-weight plastic device) may be particularly distracting; the difference in estimated weights may lead to a user's physical actions not matching up to that of an in-game avatar, as a heavier object will be swung more slowly for example. Embodiments according to the current disclosure may be particularly effective when used in conjunction with a system with a full immersion HMD, as this obscures the user's view of the input device and thus the user is only aware of the apparent weight of the input device and not the appearance, but are not limited to this.

FIG. 1 schematically illustrates the overall system architecture of a Sony® PlayStation 4® entertainment device. A system unit 10 is provided, with various peripheral devices connectable to the system unit.

The system unit 10 comprises an accelerated processing unit (APU) 20 being a single chip that in turn comprises a central processing unit (CPU) 20A and a graphics processing unit (GPU) 20B. The APU 20 has access to a random access memory (RAM) unit 22.

The APU 20 communicates with a bus 40, optionally via an I/O bridge 24, which may be a discreet component or part of the APU 20.

Connected to the bus 40 are data storage components such as a hard disk drive 37, and a Blu-ray® drive 36 operable to access data on compatible optical discs 36A. Additionally the RAM unit 22 may communicate with the bus 40.

Optionally also connected to the bus 40 is an auxiliary processor 38. The auxiliary processor 38 may be provided to run or support the operating system.

The system unit 10 communicates with peripheral devices as appropriate via an audio/visual input port 31, an Ethernet® port 32, a Bluetooth® wireless link 33, a Wi-Fi® wireless link 34, or one or more universal serial bus (USB) ports 35. Audio and video may be output via an AV output 39, such as an HDMI port.

The peripheral devices may include a monoscopic or stereoscopic video camera 41 such as the PlayStation Eye®; wand-style videogame controllers 42 such as the PlayStation Move® and conventional handheld videogame controllers 43 such as the DualShock 4®; portable entertainment devices 44 such as the PlayStation Portable® and PlayStation Vita®; a keyboard 45 and/or a mouse 46; a media controller 47, for example in the form of a remote control; and a headset 48. Other peripheral devices may similarly be considered such as a printer, or a 3D printer (not shown).

The GPU 20B, optionally in conjunction with the CPU 20A, generates video images and audio for output via the AV output 39. Optionally the audio may be generated in conjunction with or instead by an audio processor (not shown).

The video and optionally the audio may be presented to a television 51. Where supported by the television, the video may be stereoscopic. The audio may be presented to a home cinema system 52 in one of a number of formats such as stereo, 5.1 surround sound or 7.1 surround sound. Video and audio may likewise be presented to a head mounted display unit 53 worn by a user 60.

Regarding peripherals, the system unit is typically provided with at least one hand-held controller 43 such as the DualShock 4®. This controller may be used to interact with user interfaces presented by the system unit that are associated with the operating system and/or a particular game or application being run by the system unit.

Alternatively or in addition, a controller designed to assist with camera-based user interaction, such as the PlayStation Move® 42, may be provided. This controller has a wand form factor and an illuminated region that facilitates detection of the controller within a captured video image. Illuminated regions may similarly be provided on other controllers 43, such as on the DualShock 4®. Both kinds of controller comprise motion sensors to detect transverse movement along three axes and rotational movement around three axes, and wireless communication means (such as Bluetooth®) to convey movement data to the system unit. Optionally such controls can also receive control data from the system unit to enact functions such as a rumble effect, or to change the colour or brightness of the illuminated region, where these are supported by the controller. These controllers may be adapted to provide further functions, such as those described below.

The system unit may also communicate with a portable entertainment device 44. The portable entertainment device 44 will comprise its own set of control inputs and audio/visual outputs. Consequently, in a ‘remote play’ mode some or all of the portable entertainment device's inputs may be relayed as inputs to the system unit 10, whilst video and/or audio outputs from the system unit 10 may be relayed to the portable entertainment device for use with its own audio/visual outputs. Communication may be wireless (e.g. via Bluetooth® or Wi-Fi®) or via a USB cable. A portable entertainment device 44 may also be provided with a number of the features of the controllers as described above. For example a portable entertainment device 44 may be adapted to provide a rumble effect, or functions such as those described below with reference to a controller.

In operation, the entertainment device defaults to an operating system such as a variant of FreeBSD 9.0. The operating system may run on the CPU 20A, the auxiliary processor 38, or a mixture of the two. The operating system provides the user with a graphical user interface such as the PlayStation Dynamic Menu. The menu allows the user to access operating system features and to select games and optionally other content.

FIG. 2 schematically illustrates an entertainment system comprising a games console 100 such as the Sony® PlayStation 4® 10 described with reference to FIG. 1, a display 51 associated with the games console, and an input device 102 (an example of which could be a device such as the controller 43 of FIG. 1). While the example of a games console 100 has been provided, this device could be any processing apparatus that receives inputs from a user and uses the input commands to modify the image shown on the display 51; for example, a computer or a mobile device. The display 51 may be any apparatus capable of displaying an image, such as a television connected to the games console 100 or an HMD associated with the console (as denoted by reference 53 of FIG. 1). The input device 102 is operated by the user in order to generate input commands for the games console 100, the games console 100 using these commands to control the processing that is performed (such as the action in a game or the selection of menu items). The input device 102 is connected to the games console 100 via a connection 103 which may be wired, for example using a USB connection, or wireless using any suitable wireless communication protocol.

FIG. 3 is a schematic illustration of the input device 102. The device comprises a transmitter 200 for transmitting user inputs obtained through user input section 201 to the games console 100 through the connection 103. The user input section 201 may, for example, determine user inputs through a user pressing buttons associated with the input device or through motion detection, or a combination of the two. The receiver 202 is operable to receive control signalling from the games console 100. This control signalling may comprise any information about how the input device 102 is operated, for example controlling any lights present on the device, any rumble features present in the device, or the operation of the torque generating unit 204. If conversion of the signal is required, the receiver 202 provides the received control signalling to the converter 203, which is operable to convert the received signal into a signal that is suitable for the torque generating unit 204. In the case that a digital signal is supplied to the input device 102 and a corresponding analogue signal is required by the torque generating unit 204, the converter may be implemented as a standard DAC integrated circuit, or any suitable alternative. The analogue signal is then provided by the converter 203 to the torque generating unit 204; the torque generating unit 204 then generates a torque in dependence upon the analogue signal. An example of a torque generating unit is a rotary actuator, although torque may be generated in other manners—such as a gyro arrangement with a motor that is able to cause the gyro arrangement to spin in the desired manner. It is also envisaged that an array of rotary actuators could be provided to the input device, as a way of allowing torque to be generated in a plurality of directions. Alternatively a single rotary actuator could be provided that may be configured to generate a torque in any one of a plurality of directions, for example by allowing the axis of rotation of the rotating element to be realigned. An example of such an arrangement is providing a rotary actuator in an enclosure that may be rotated independently of the input device 204, wherein the axis of rotation of the rotary actuator is dependent on the orientation of such an enclosure.

The torque generating unit 204 generates a torque that is determined by the following equation:

τ=r×F

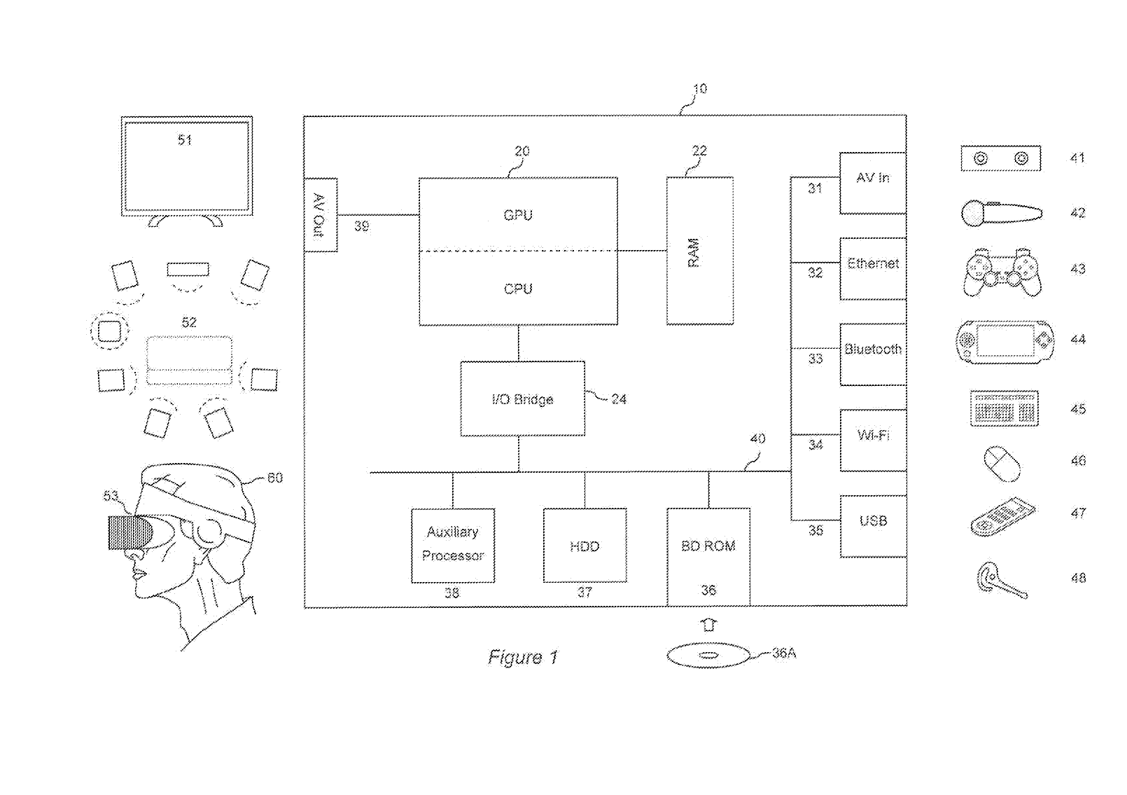

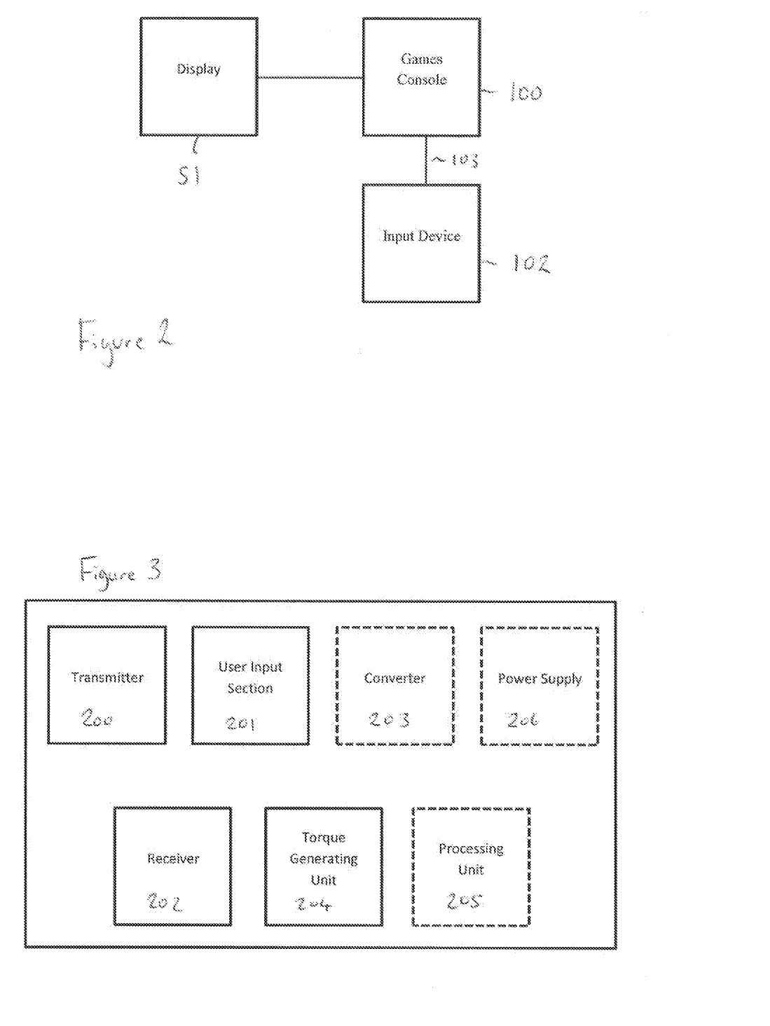

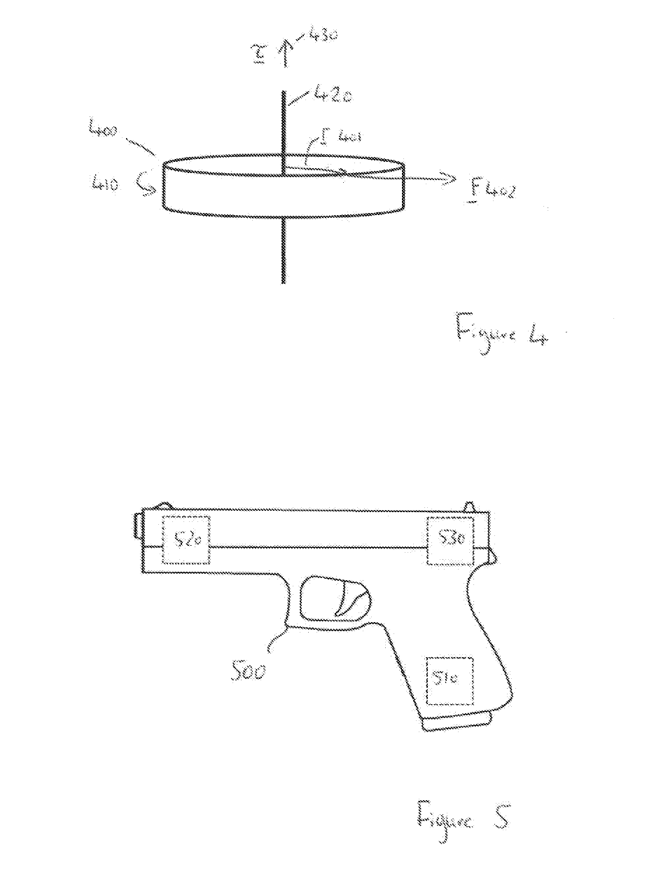

In the example of using a rotary actuator as the torque generating unit 204, a force (F) is applied to a rotatable portion, such as a disk. This force is applied to a part of the rotatable portion at a position denoted by the vector r as measured from the centre (i.e. axis of rotation) of the rotatable portion. This gives rise to a torque τ at a right angle to each of the other two vector quantities as a result of the cross product. FIG. 4 illustrates an example of this arrangement.

FIG. 4 shows an example of a system that may be used to generate a torque. A disk 400 has a force F 402 applied at a position denoted by the position vector r 401. This results in the disk obtaining an angular velocity in the direction shown by the arrow 410 about the axis of rotation 420. In this configuration, the torque τ is generated in the direction of the arrow 430; the opposite torque is obtained when an opposite force is used to rotate the disk 400 in the other direction. Thus such an arrangement may generate a force in two directions, which may be perceived by a user holding a device containing such an arrangement as weight. By providing several such torque generating units 204 or allowing the rotation to be performed in a greater number of directions a force may be generated in a greater number of directions.

Although FIG. 4 illustrates an example in which the force F is applied to the outside of a disk 400, embodiments should not be limited by this. The disk 400 could instead be a rotatable element of any shape, and the force could be applied on any surface. For instance, the rotation of the element could be driven by a force applied to an interior surface of the element; an example of this is when an axle about which the rotating element rotates is used to apply the force to the rotating element.

It will be appreciated that the application or torque simulates additional mass in the input device by creating rotational or gyroscopic inertia. Hence whilst no physical mass is added, the input device becomes harder to move and this is perceived by the user as being due to additional mass.

The torque generating unit 204 is operable to generate sufficient torque and hence, indirectly, sufficient inertia, to have a perceptible effect on the apparent mass of the input device. Meanwhile, other potential rotating masses in the device, such as a small off-balance mass that is spun to provide a rumble effect, to do not generate sufficient torque or inertia to create a perceptible apparent increase in mass, and furthermore do not produce forces in any consistent direction.

The input device 102 may also comprise a processing unit 205 to process the signals for transmission or those that are received, or for performing any other functions associated with the input device 102. The input device 102 may further comprise a power supply 206, particularly if the connection 103 is wireless, although a separate power source could be provided such as a cable from the games console 100 which may or may not be associated with the connection 103.

In some embodiments the input device 102 is a gamepad, for example similar to the DualShock 4® controller 43, albeit with the added functionality of the torque generating unit. In other embodiments, the input device 102 may be closer in form to a simpler controller such as the PlayStation Move® 42 of FIG. 1. In further embodiments, the input device 102 may have the form of a weapon such as a gun. It is also envisaged that the input device could be formed as a wearable unit, such as a glove or as part of an HMD device, that generate a simulated mass that may act directly on the user's hand or head. These could be used in a number of ways, such as to simulate the wearing of a helmet or gauntlets, with gloves being particularly useful for simulating the picking up of ‘heavy’ in-game objects; this allows the simulated mass to be applied indirectly to any object that is handled by the user, even if it is not a part of the entertainment system.

In any of the above-described embodiments a plurality of torque generating units 204 may be supplied, either adjacent to one another or in separate portions of the input device 102. Having adjacent torque generating units 204 enables an equivalent torque to a single torque generating unit 204 arrangement, but with a lower number of revolutions per minute required from each torque generating unit 204 due to the increase in the rotating mass. This is advantageous in that the spin-up/spin-down time of each torque generating unit 204 is reduced.

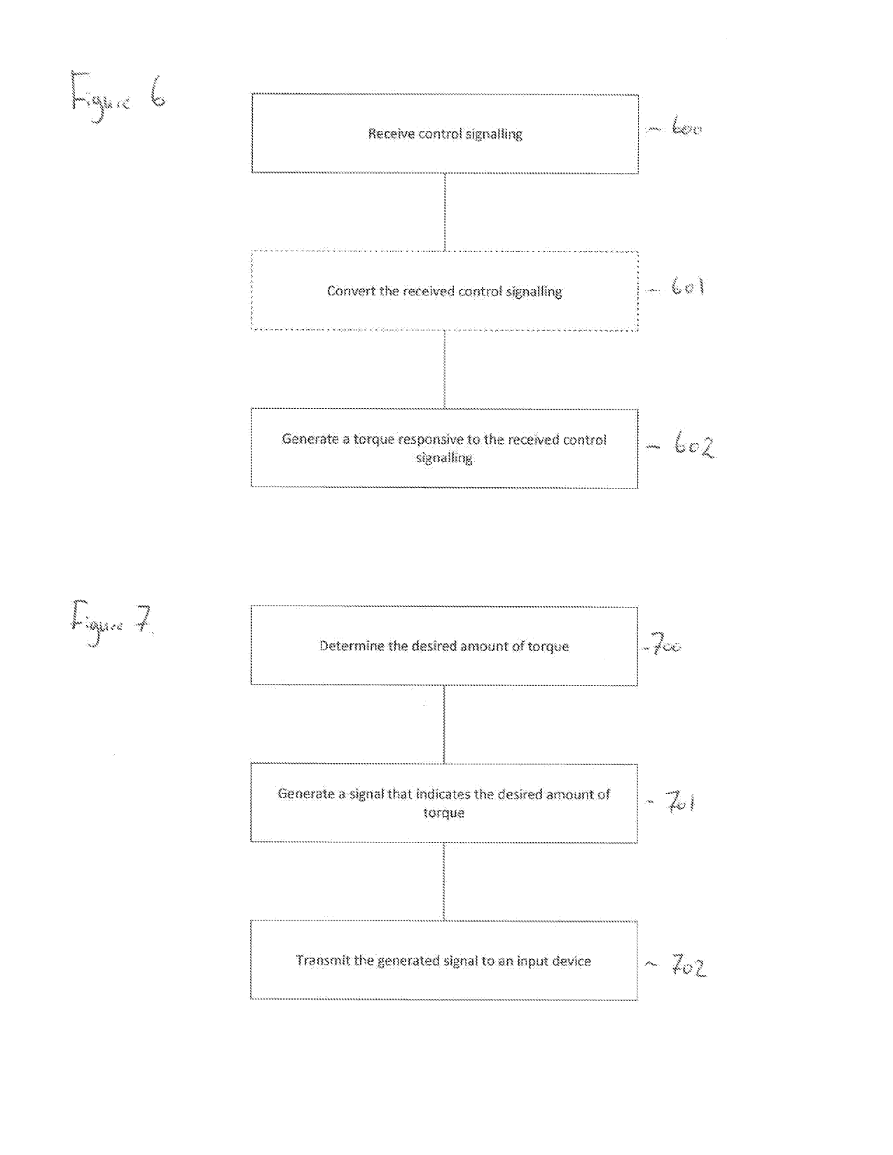

An embodiment in which multiple torque generating units are implemented in different locations is schematically illustrated in FIG. 5, in which the input device is designed to be in the shape of a gun. In this example, three torque generating units are provided in an input device 500: a first torque generating unit 510 in the grip of the gun, a second torque generating unit 520 at the front end of the barrel (the end furthest from the user in normal use), and a third torque generating unit 530 at the rear end of the barrel.

Such an arrangement may be advantageous in that it is operable to provide a different apparent weight distribution to the input device 500. In the example of the input device 500 formed in the shape of a gun, such an arrangement is able to simulate a greater number of weapons; for example, generating a torque using the second torque generating unit 520 is able to simulate a front-heavy weapon such as handgun with a long barrel. Alternatively, the input device 500 could have a rear-heavy simulated weight distribution by employing the third torque generating unit 530 to a greater degree than the second torque generating unit 520. The first torque generating unit 510 could be used to fine-tune the balance between the other two units, or could be used separately to simulate a weight such that the user of the input device 500 is able to determine whether they have the maximum allowed amount of ammunition remaining for the currently equipped weapon, are out of bullets and thus needing to reload, or any ammunition level between the two.

FIG. 6 schematically illustrates a torque generation process implemented by a device such as the input device 102, in an embodiment in which conversion of the signal is performed (this step may not be required depending on the format of the signal that is generated). At a step 600, control signalling is received by the input device 102, and at a step 601 the control signalling is converted from a digital signal to an analogue signal. At step 602 a torque is generated based upon this analogue signal. This signal could indicate a quantified amount of torque to be generated, or it could simply be an indication of a desired level of torque such as ‘off’, ‘low’, ‘medium’, or ‘high’, or a differential step or value, such as ‘increase’ or ‘decrease’ by a default or specified amount. Similarly if the spin-up or spin-down behaviour of the torque generating unit is known, the signal may last for or indicate a time period during which the unit should spin up or down, as appropriate. As described above, the signal need not be provided as a digital signal and converted into an analogue signal; indeed it could be provided as a digital signal and not converted or provided as an analogue signal and not converted, for example.

This signal may cause the torque generating unit to provide a greater torque (in the example of a rotary actuator, by applying a greater force to the rotating element), or it may cause a braking to be applied in the case in which a lesser amount of torque is desired. In the latter case, a braking system is used to reduce the angular speed of the rotating element. This braking system could be implemented either by simply not supplying power to the circuitry causing the rotation if friction is sufficient to cause a significant spin down of the rotating element. Alternatively, if the rotating element is geared and driven by a pinion, the driving force may be reduced to a level that will produce the desired torque. As a further example, a simple friction brake could be applied to the rotating element in order to reduce the speed.

It is also noted that the torque that is generated by the torque generating unit 204 may depend on other factors than just the received signal. For example, user settings could be applied in order to scale the torque generated to a more suitable level; for example, children may wish to use a device that applies a smaller sensation of weight than an adult due to differing levels of strength. These may be set on the input device, or on via an interface on the games console to alter the values of received signals, or responsive to registered details of the user under whose account the game is being played. Where the signals do not specify values, but indicate a default setting, optionally these default values may be transmitted in a preparatory step, or one of a set of default values for different user profiles may be selected. Additionally, external factors such as the remaining battery power in the input device 102 may be considered. For example, if the input device 102 has a low battery it may be desirable for a user to not experience the simulated weight that results from the generation of torque and to instead prolong the battery life of the input device 102 and thus extend the amount of time for which the user may interact with the games console 100. Alternatively, these factors could be implemented in the control signalling by the games console 100.

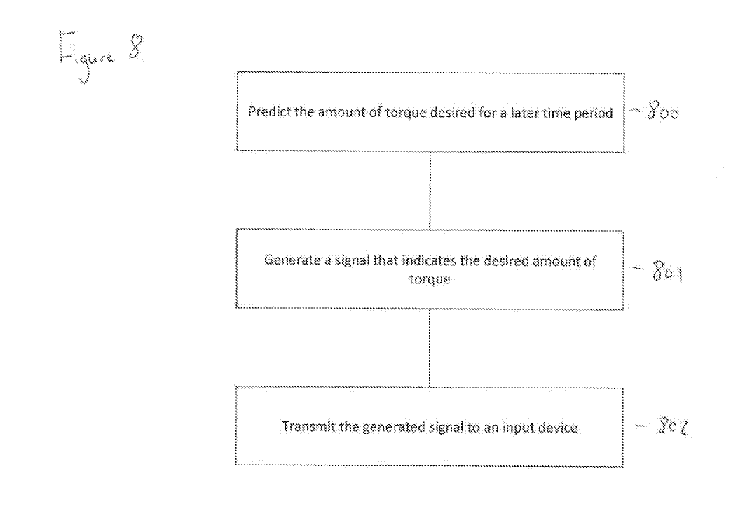

FIG. 7 schematically illustrates a signal generation method performed by the games console 100. At step 700 the desired torque is determined. This may be in the form of analysing a currently running application or game in order to estimate a magnitude and direction of the desired torque, for example by analysing features in a game such as an equipped weapon type or size. For example, each weapon class could have an associated ‘weight’ value from which a desired torque to be generated by the input device 204 could be derived. Alternatively, an in-game environment could be generated using a physics engine from which a processor could extract weight values for any in-game objects; this could then be used to derive a value for the desired torque associated with an in-game object.

Alternatively, the application or game that is running could be designed with the desired torque values already defined for specific objects, events or circumstances within the context of the game or application, such that information about the desired torque can be output without the games console 100 having to perform an analysis. At a step 701 a signal is generated that corresponds to the desired torque, and this signal is then transmitted to the input device 102 at a step 702. The signal may generated in dependence upon content for display on a display associated with the processing apparatus, as it is to this content that the desired torque is related.

Hence by way of summary, method for the entertainment device of controlling the input device comprises the steps of obtaining information about the amount of torque to generate in the torque generating unit of the input device (for example using the above provided or calculated weights), generating control signalling indicating the amount of torque (for example as an analogue or digital signal in one of the formats described previously herein), and transmitting the control signalling to the input device (for example via a wired or wireless connection).

FIG. 8 schematically illustrates an alternative method of generating a signal corresponding to a desired torque. This method acknowledges that there may be a non-trivial spin-up and spin-down time associated with the torque generating unit, and therefore if the signals are generated at the same time as an on-screen action in a game (for example) the resulting lag in generating the desired torque may result in a break in immersion for the user as the input device's apparent mass would not correspond to in-game action. In order to account for such a lag, at a step 800 the desired torque to be applied at a later time is predicted. This could be performed in the same manner as the step 700 in FIG. 5 if the delay between processing in-game action and displaying it is sufficiently long for the desired torque to be generated. Alternatively, torque information could be predicted based on an analysis of the in-game content; for example, if a compulsory weapon change that results in a change in the torque is to happen at a future time plenty of warning can be given by the game to the games console 100 so as to prepare and send a signal identifying the desired torque to the input device 102 in good time to prepare. At a step 801 a signal is generated that corresponds to the predicted desired torque, effectively meaning that the signal corresponds to the generation of a torque at a time later than that at which it is received by the input device, and this signal is then transmitted to the input device 102 at a step 802. In some embodiments, applications or games may be produced with such a lag in mind. For example, in a first-person shooting game a change of weapon that is associated with a change in the desired torque may have a greater length of time associated with the weapon change so as to provide a suitable period of time for the torque to be generated before the user fully interacts with the new weapon.

Generating a torque may consume a significant amount of power, as the torque generating unit 204 may cause the mass to spin at several thousand (or more) revolutions per minute. This power consumption is manageable in a wired connection in which power may be obtained by the input device 102 through the connection, but increasingly peripherals are being designed as wireless units that instead run on battery power. In some embodiments, this problem is alleviated by providing circuitry that is operable to recoup energy from the torque generating unit 204 when it spins down.

In some embodiments, this is implemented as part of the braking system used to reduce the rotation speed of the torque generating unit 204. For example, by reducing the applied voltage to a level lower than the electromotive force of the circuit and therefore causing a reverse current and reverse torque, a portion of the energy used to spin-up the torque generating unit 204 may be used to charge a battery whilst also causing deceleration of the rotating mass. Alternatively a dynamo may be provided, either as a part of the torque generating unit 204 or as a separate unit, that is configured to generate energy from the spinning down of the torque generating unit 204 and use this energy to charge a battery.

It will be appreciated that the methods found herein may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a tangible non-transitory machine-readable medium such as a floppy disk, optical disk, hard disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An input device for use with a processing apparatus, the input device comprising:
a transmitter operable to transmit user inputs to the processing apparatus;
a receiver operable to receive control signalling from the processing apparatus; and
a torque generating unit operable to generate torque responsive to the control signalling so as to increase the apparent mass of the input device when moved by a user.

2. An input device according to claim 1, wherein the torque generating unit comprises at least one rotary actuator.

3. An input device according to claim 1, wherein the user inputs are determined by detected motion.

4. An input device according to claim 1, wherein the signal is generated in dependence upon content for display on a display associated with the processing apparatus.

5. An input device according to claim 1, wherein a plurality of torque generating units are provided at different locations in the input device.

6. An input device according to claim 1, wherein the control signalling corresponds to the generation of a torque at a time later than that at which the control signalling is received by the input device.

7. An input device according to claim 1, comprising a charger operable to charge a battery by generating energy from the spinning down of the torque generating unit.

8. An input device according to claim 1, comprising a converter operable to convert a received digital signal into an analogue signal, and wherein the control signalling is in the form of a digital signal.

9. An entertainment device comprising:
a control signalling generator operable to generate control signalling indicating an amount of torque;
a transmitter operable to transmit the control signalling to an input device comprising a torque generating unit operable to generate torque responsive to the control signalling so as to increase the apparent mass of the input device when moved by a user.

10. An entertainment device according to claim 9, comprising a torque amount information generator operable to generate information about the amount of torque that should be provided to an input device associated with the entertainment device.

11. An entertainment device according to claim 9, in which the torque amount information generator generates information about the amount of torque responsive to one or more selected from the list consisting of:
i. a value stored in association with a virtual object; and
ii. a value calculated using simulated physics of a virtual environment.

12. An entertainment device according to claim 9, wherein the control signalling corresponds to the generation of a torque at a time later than that at which the control signalling is received by the input device.

13. A method of operating an input device, the method comprising:
receiving control signalling from a processing apparatus; and
generating a torque in the input device responsive to the control signalling so as to increase the apparent mass of the input device when moved by a user.

14. A method of controlling an input device, comprising the steps of:
obtaining information about the amount of torque to generate in a torque generating unit of the input device;
generating control signalling indicating the amount of torque; and
transmitting the control signalling to the input device.

15. A computer readable medium having computer executable instructions adapted to cause a computer system to perform a method comprising the steps of:
receiving control signalling from a processing apparatus; and
generating a torque in the input device responsive to the control signalling so as to increase the apparent mass of the input device when moved by a user.

16. A computer readable medium having computer executable instructions adapted to cause a computer system to perform a method comprising the steps of:
obtaining information about the amount of torque to generate in a torque generating unit of the input device;
generating control signalling indicating the amount of torque; and
transmitting the control signalling to the input device.
